(19) United States
(12) Patent Application Publication
(10) Pub. No.: US 2007/0023546 A1
(43) Pub. Date: Feb. 1, 2007

(54) Nozzle structure for a high-pressure spray head

(76) Inventor: Chih-Min Yu, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/193,491

(22) Filed: Aug. 1, 2005

(51) Int. Cl. A62C 31/02; B05B 1/04; B05B 1/26

(52) U.S. Cl. 239/589; 239/594; 239/601

(57) ABSTRACT

A nozzle structure for a high-pressure spray head includes a nozzle and a nozzle head. The nozzle is made of iron in a concave shape. The nozzle head is disposed in the nozzle. The nozzle head includes a glass ring and a ceramic ring. The ceramic ring comprises an outlet therein. The nozzle and the ceramic ring are combined together by means of the glass ring.

### BACKGROUND OF THE INVENTION

1. Field of the Invention

This invention relates to a nozzle structure for a high-pressure spray head, and more particularly to a nozzle combined with a nozzle head in a sintering method. The nozzle head comprises a ceramic ring having an outlet.

2. Description of the Related Prior Art

As shown in FIG. 3, a conventional nozzle A is made of metal material in an integral one. The nozzle A is formed with a nozzle head A1 at the center.

Although this design provides convenience to a user, the product may produce ragged edge during manufacture, in particular at the nozzle head A1, which affects the quality of spraying. This situation will become worse after a period of time and the spraying will not be mist but in larger particles.

### SUMMARY OF THE INVENTION

It is the primary object of the present invention to provide a nozzle structure for a high-pressure spray head, which is formed with a ceramic ring having an outlet in a sintering method so as to avoid ragged edge produced during manufacture.

The nozzle structure comprises a nozzle and a nozzle head. The nozzle is made of iron in a concave shape. The nozzle head is disposed in the nozzle. The nozzle head comprises a glass ring and a ceramic ring. The ceramic ring comprises an outlet therein. The nozzle and the ceramic ring are combined together by means of the glass ring.

It is another object of the present invention to provide a nozzle structure for a high-pressure spray head, which has no ragged edge.

It is a further object of the present invention to provide a nozzle structure for a high-pressure spray head, which endures high pressure and wear-proof.

### BRIEF DESCRIPTION OF THE DRAWINGS

FIG. 1 is a cross-sectional view of the present invention;

FIG. 2 is a cross-sectional view of the present invention in an operating status; and

FIG. 3 is a cross-sectional view of a prior art.

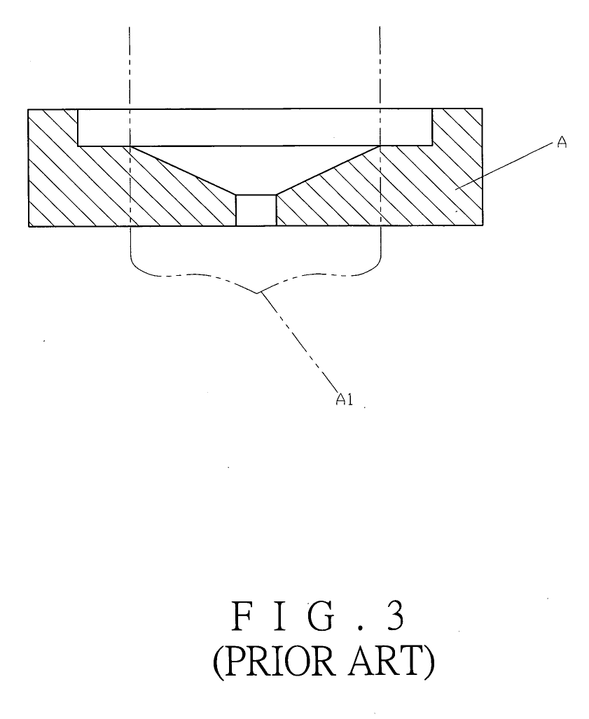

### DETAILED DESCRIPTION OF THE PREFERRED EMBODIMENT

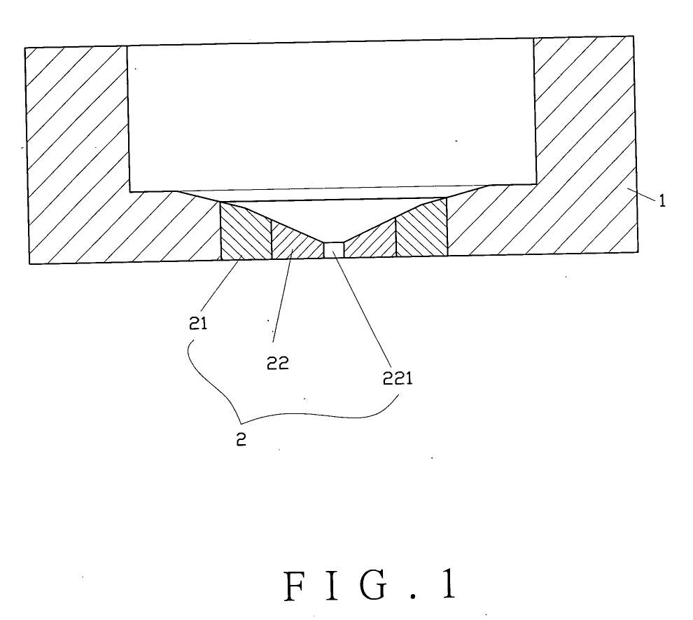

As shown in FIG. 1, the present invention comprises a nozzle 1 and a nozzle head 2.

The nozzle 1 is made of iron in a concave shape. The nozzle head 2 is disposed in the nozzle 1.

The nozzle head 2 includes a glass ring 21 and a ceramic ring 22. The ceramic ring 22 comprises an outlet 221 therein.

The nozzle 1 and the ceramic ring 22 are combined together by means of the glass ring 21 to function as a medium.

In this embodiment, the nozzle 1, the glass ring 21 and the ceramic ring 22 are formed with powder in a sintering method, separately, and combined together at 900 degrees Centigrade with nitrogen under high pressure to form an integral one.

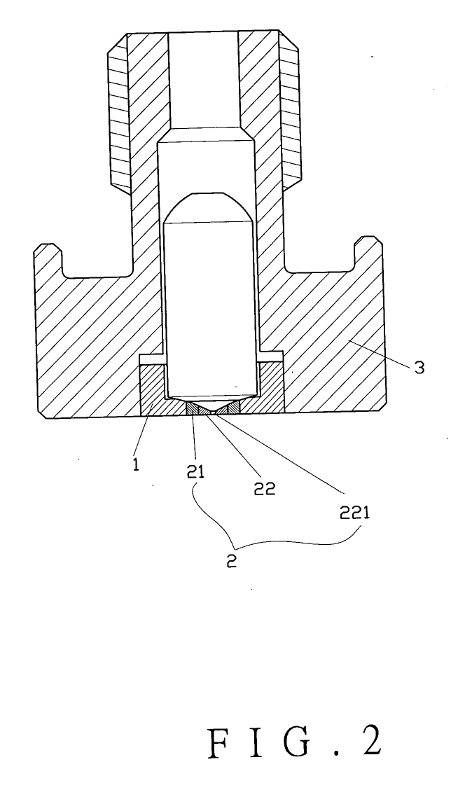

As shown in FIG. 2, the nozzle 1 and the nozzle head 2 are coupled with a spray head 3 to show the operating status of the present invention.

I claim:

1. A nozzle structure for a high-pressure spray head comprising a nozzle and a nozzle head;
said nozzle being a concave shape, said nozzle head being disposed in said nozzle;
said nozzle head comprising a glass ring and a ceramic ring, said ceramic ring comprising an outlet therein, said nozzle and said ceramic ring being combined together by means of said glass ring.

2. The nozzle structure for a high-pressure spray head, as recited in claim 1, wherein said nozzle is made of iron.
